(19) United States
(12) Patent Application Publication
(10) Pub. No.: US 2026/0220089 A1
(43) Pub. Date: Jul. 30, 2026

(54) Semantically Preserved File Compression System Utilizing Optimized Lookup Tables Enabling Active Processing of Compressed Data

(71) Applicant: Galacto Corp, Stillwater, OK (US)

(72) Inventor: Daniel J. Mueller, Stillwater, OK (US)

(73) Assignee: Galacto Corp, Stillwater, OK (US)

(21) Appl. No.: 19/040,920

(22) Filed: Jan. 30, 2025

(51) Int. Cl. G06F 16/174; G06F 40/242; G06F 40/284; G06F 40/30; G06N 3/0985

(52) U.S. Cl. CPC G06F 16/1744; G06F 40/242; G06F 40/284; G06F 40/30; G06N 3/0985

(57) ABSTRACT

The invention provides a method and file format for semantically preserving compression of any file type and/or data using a multi-level charterization process and optimized lookup tables. By leveraging advanced pattern matching and efficient data structures, the method achieves higher compression ratios while maintaining the original data's meaning and functionality. The compressed data is stored in a new file format with a unique extension and can be accessed via a virtual service over an API, facilitating widespread integration and use.

### FIELD OF THE INVENTION

The present invention encompasses systems and methods for data compression and decompression.

### BACKGROUND OF THE INVENTION

The present invention relates to data compression technologies and, more specifically, to embodiments of a new compression system, method, and file format that computes and stores semantically preserved representations of any file type using advanced compression techniques. The systems, files, and methods of the present invention leverage optimized lookup tables and a multi-level charterization processes to enhance compression efficiency while maintaining the intrinsic meaning and functionality of the original data.

The rapid growth of data across various domains, including natural language processing, artificial intelligence and large language models, genomics, multimedia, and more, has intensified the need for efficient data compression methods. Traditional compression algorithms often focus on reducing data size by eliminating redundancy but may not preserve the semantic integrity of the data. In applications where the meaning and functionality of the data are critical, such as in large language models or genomic data analysis, there is a need for compression techniques that retain semantic content while achieving high compression ratios.

Existing methods may not effectively handle the complexity and diversity of modern data types, leading to inefficiencies in storage and transmission. Therefore, a universal compression method that can semantically preserve any file type and optimize compression using advanced lookup tables is highly desirable.

### BRIEF SUMMARY OF THE INVENTION

The present invention introduces a new file type and various embodiments of a corresponding compression and decompression method and system that computes semantically preserved representations of any file type using a multi-level charterization process and optimized lookup tables. The method is designed to handle various data formats, including text, binary files, images, audio, and video.

One embodiment of the present invention is a method for compressing data into semantically preserved representations This embodiment comprises an electronic system having at least one processor, and a memory coupled to the at least one processor comprising instructions executable by the at least one processor. The at least one processor operable when executing the instructions to: (1) read input data; (2) perform a level 1 charterization; (3) perform a level 2 charterization; and (4) store all assigned charters in at least one deduplication database. The level 1 charterization of this embodiment comprises: (1) identifying level 1 prefixes, level 1 suffixes, and level 1 prefix-suffix combinations in the input data; (2) calculating a count for and an associated probability of each of the level 1 prefix-suffix combinations; (3) updating at least one level 1 probabilistic table with the level 1 counts and associated probabilities; (4) detecting low-probability level 1 prefix-suffix combinations; (5) assigning a level 1 charter to each detected low-probability level 1 prefix-suffix combination; and (6) replacing each of the low-probability level 1 prefix-suffix combinations with the assigned level 1 charter to create a level 1 output. A level 2 charterization according to this embodiment comprises: (1) identifying level 2 prefixes, level 2 suffixes, and level 2 prefix-suffix combinations in the level 1 output; (2) calculating a count for and an associated probability of each of the level 2 prefix-suffix combinations; (3) updating at least one level 2 probabilistic table with the level 2 counts and associated probabilities; (4) detecting low-probability level 2 prefix-suffix combinations; (5) assigning a level 2 charter to each detected low-probability level 2 prefix-suffix combination; and (6) replacing each of the low probability level 2 prefix-suffix combinations with the assigned level 2 charter to create a level 2 output.

Various embodiments of the can incorporate one or more of the following: (1) where the probability of each step of detecting low-probability prefix-suffix combinations is defined according to at least one predetermined threshold; and/or (2) where a pattern-matching automaton for charter pattern matching is used for the steps of: (a) detecting low-probability level 1 prefix-suffix combinations, (b) assigning a level 1 charter to each detected low-probability level 1 prefix-suffix combination, (c) detecting low-probability level 2 prefix-suffix combinations, and (d) assigning a level 2 charter to each detected low-probability level 2 prefix-suffix combination.

Another embodiment of the present invention is a non-transitory computer-readable storage medium storing one or more programs for compressing data, the one or more programs comprising instructions, which, when executed by at least one processor of an electronic system, cause the electronic system to: (1) receive input data; (2) read the input data; (3) perform a level 1 compression on the input data; (4) perform a level n compression; and (5) and create at least one charter-encoded file format from the level n output. For this embodiment, the level 1 compression comprises the steps of (1) updating a level 1 P-Table based upon a predefined probability threshold; (2) detecting at least one low-probability n-gram; (3) creating a distinct level 1 charter for each low-probability n-gram; and (4) replacing each detected n-gram with its level 1 charter. For this embodiment, performing a level n compression wherein n is a number greater than 1, comprises the steps of: (1) updating a level n P-Table based upon a predefined probability threshold; (2) detecting at least one low-probability n-gram; (3) creating a distinct level n charter for each low-probability n-gram; and (4) replacing each low-probability n-gram with a level n token to create level n output.

Another embodiment of the present invention is a method for decompressing data from a compressed format, comprising an electronic system having at least one processor, and a memory coupled to the at least one processor comprising instructions executable by the processors. The at least one processor operable when executing the instructions to: (1) read a plurality of compressed data and associated metadata containing at least one token; (2) utilize a pattern-matching automata and at least one lookup table to map each tokens back to a corresponding charter; (3) reconstruct an original data by replacing each token with its corresponding charters to produce decompressed data; and (4) verify the integrity and functionality of the decompressed data. One embodiment of this method comprises having the compressed data stored in at least one cloud-based database that is configured to be accessible by multiple users through an API.

Another embodiment of the present invention is a method of using a charter-encoded file format in its compressed state by accessing a plurality of compressed data wherein the compressed data comprises n-level charter-encoded text data having semantic accuracy preserved and reading the compressed data without decompressing the data. In some embodiments, a large language model is trained on the compressed data by (1) selecting a large language model architecture that is appropriate for the compressed data; (2) configuring hyperparameters such as learning rate, batch size, and number of epochs to suit the compressed data; (3) initiating the training process using the compressed data; and (4) validating the model continuously during training.

Another embodiment of the present invention is a system for semantically preserving data compression, the system comprising: at least one processor, and a memory coupled to the at least one processor comprising instructions executable by the at least one processor. For this embodiment, the at least one processor is operable when executing the instructions to: (1) read input data; (2) identify level 1 prefixes, level 1 suffixes, and level 1 prefix-suffix combinations in the input data; (3) calculate a count for and an associated probability of each of the level 1 prefix-suffix combination; (4) update at least one level 1 probabilistic table with the level 1 counts and associated probabilities; (5) detect low-probability level 1 prefix-suffix combinations; (6) assign a level 1 token to each detected low-probability level 1 prefix-suffix combination; (7) replace each of the low-probability level 1 prefix-suffix combinations with the assigned level 1 charter to create a level 1 output; (8) identify level 2 prefixes, level 2 suffixes, and level 2 prefix-suffix combinations in the level 1 output; (9) calculate a count for and an associated probability of each of the level 2 prefix-suffix combination; (10) update at least one level 2 probabilistic table with the level 2 counts and associated probabilities; (11) detect low-probability level 2 prefix-suffix combinations; (12) assign a level 2 token to each detected low-probability level 2 prefix-suffix combination; (13) replace each of the low probability level 2 prefix-suffix combinations with the assigned level 2 token to create a level 2 output; and (14) store all assigned tokens in at least one deduplication database.

Another embodiment of the present invention is a computer implemented method for transforming input data into a charter-encoded file format, the method employing at least one processor, and a memory coupled to the at least one processor comprising instructions executable by the at least one processor. For this embodiment, the at least one processor is operable when executing the instructions to: (1) receiving a plurality of input data; (2) reading the input data; (3) performing a level 1 compression on the input data; (4) performing a level n compression wherein n is a number greater than 1; and (5) creating at least one charter-encoded file format from the level n output. For this embodiment, the level 1 compression comprises: (1) updating a level 1 P-Table based upon a predetermined probability threshold; (2) detecting low-probability n-grams; (3) creating at least one distinct level 1 charter, and (4) replacing each detected n-grams with a token. For this embodiment, performing a level n compression comprises: (1) updating a level n P-Table based upon a predetermined probability threshold; (2) detecting low-probability n-grams; (3) creating at least one distinct level n charter, and (4) replacing each level n charter with a level n token to create level n output.

Another embodiment of the present invention is a computer implemented method for compressing and decompressing data using a computing device comprising a processor in communication with a non-transitory processor-readable storage medium and a memory. The computer is configured to: (1) receive input data; (2) read the input data into smaller data segments; (3) process the data segments through a level 1 compression to generate level 1 output; (4) process the level 1 output through a level 2 compression to generate level 2 output; (5) creating a charter-encoded file from the level 2 output; (6) parsing the charter-encoded file; (7) performing a level 2 decompression on the charter-encoded file; (8) performing a level 1 decompression on the charter-encoded file to produce a restored file; and (9) validating the restored file for semantic accuracy.

### BRIEF DESCRIPTION OF THE SEVERAL VIEWS OF THE DRAWINGS

For the purpose of facilitating understanding of the invention, the accompanying drawings and description illustrate embodiments thereof, from which the invention, various embodiments of its structures, construction, and methods of operation, and many advantages, may be understood and appreciated. The accompanying drawings are hereby incorporated by reference.

FIG. 1 is an overview of one embodiment of a multi-level charterization method, illustrating the flow from input data through Level 1 and Level 2 charterizations to become compressed output;

FIG. 2 is a diagram of one embodiment of probabilistic tables (“P-Tables” or “p-tables”) and their role in storing prefix-suffix relationships during compression for one embodiment of the present invention;

FIG. 3 is a representation of exemplary and nonlimiting use of the Aho-Corasick automata used for efficient pattern matching in charter detection and replacement in one embodiment of the present invention;

FIG. 4 is one embodiment of a structure of a new charter-encoded file format;

FIG. 5 is a flowchart of one embodiment of a compression and a decompression process, including the use of optimized lookup tables and semantic preservation steps;

FIG. 6 is a schematic illustrating one embodiment of a computer system to implement at least one embodiment of the present invention method;

FIG. 7 illustrates an example of the interrelationships between charterization and a P-table according to one embodiment of the present invention; and

FIG. 8 illustrates one embodiment of training an LLM according to the present invention.

### DETAILED DESCRIPTION OF THE INVENTION

The following describes example embodiments in which the present invention may be practiced. This invention, however, may be embodied in many different ways, and the descriptions provided herein should not be construed as limiting in any way. Among other things, the following invention may be embodied as methods, systems, or devices. The following detailed descriptions should not be taken in a limiting sense. The accompanying drawings are hereby incorporated by reference.

Before the example embodiments of the devices and methods according to the present disclosure are disclosed and described below, it is to be understood that embodiments are not limited to those described within this disclosure. Numerous modifications and variations therein will be apparent to those skilled in the art and remain within the scope of the disclosure. It also is to be understood that the terminology used herein is for the purpose of describing specific embodiments only and is not intended to be limiting. Some embodiments of the disclosed technology will be described more fully hereinafter with reference to the accompanying drawings. This disclosed technology, however, may be embodied in many different forms and should not be construed as limited to the embodiments set forth therein.

If the specification states a component, element, part, or feature “may,” “can,” “could,” or “might” be included or have a characteristic, then that particular component or feature is not required to be included or have the characteristic.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes that particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The terms “connected”, “interconnected”, “in communication”, or “coupled” and related terms are used in an operational sense and are not necessarily limited to a direct physical connection or coupling. As an example, two or more devices, databases, websites, or platforms may be coupled directly, or via one or more intermediary channels or devices. They may be hardwired to each other or connected without hardwiring, such as by wi-fi, Bluetooth®, or cellular service. As another example, devices, databases, websites, or platforms may be coupled in such a way that information can be passed between them, while sharing or not sharing any physical connection with one another. Based on the disclosure provided herein, one of ordinary skill in the art will appreciate a variety of ways in which connection or coupling exists in accordance with the aforementioned definition.

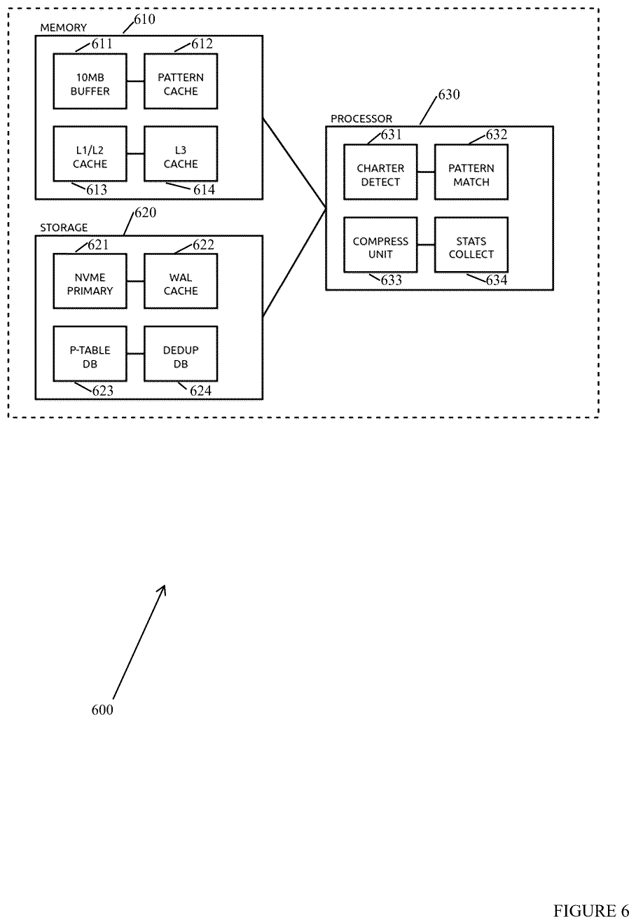

Hardware. Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 6 is an example of one embodiment of a computer system with which embodiments of the present invention method 100 may be utilized. According to the present example, the computer system includes a bus, at least one processor, at least one communication port, a main memory, a removable storage media, a read only memory, and a mass storage.

Processor(s) can be any known processor, such as, but not limited to, an Intel® Itanium® or Itanium 2® processor(s), or AMD® Opteron® or Athlon MP® processor(s), or Motorola® lines of processors. Communication port(s) can be any of an RS-232 port for use with a modem-based dialup connection, a 10/100 Ethernet port, or a Gigabit port using copper or fiber. Communication port(s) may be chosen depending on a network such a Local Area Network (“LAN”), Wide Area Network (“WAN”), or any network to which the computer system connects.

Main memory can be Random Access Memory (“RAM”), or any other dynamic storage device(s) commonly known in the art. Read only memory can be any static storage device(s) such as Programmable Read Only Memory (“PROM”) chips for storing static information such as instructions for processor.

Mass storage device can be used to store information and instructions. For example, hard disks such as the Adaptec® family of SCSI drives, an optical disc, an array of disks such as RAID, such as the Adaptec family of RAID drives, or any other mass storage devices may be used.

Bus communicatively couples processor(s) with the other memory, storage, and communication blocks. Bus can be a PCI/PCI-X or SCSI based system bus depending on the storage devices used.

Removable storage media can be any kind of external hard-drives, floppy drives, IOMEGA® Zip Drives, Compact Disc-Read Only Memory (“CD-ROM”), Compact Disc-Re-Writable (“CD-RW”), Digital Video Disk-Read Only Memory (“DVD-ROM”).

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

The invention comprises various embodiments of systems and methods for compressing data into semantically preserved, compact representations using a multi-level charterization process 20 and optimized lookup tables. The methods and systems are applicable to any file type and result in a new charter-encoded file format 400 that is both efficient and versatile. For ease of this discussion, the various embodiments of the novel file format 400 of the present invention are referred to individually and collectively as a “charter-encoded file format 400” or “galacto file 400.”

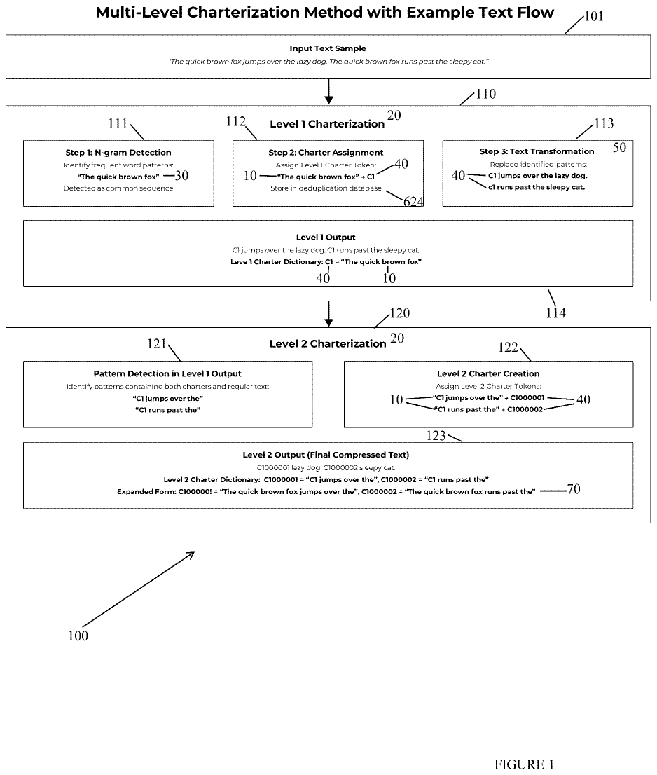

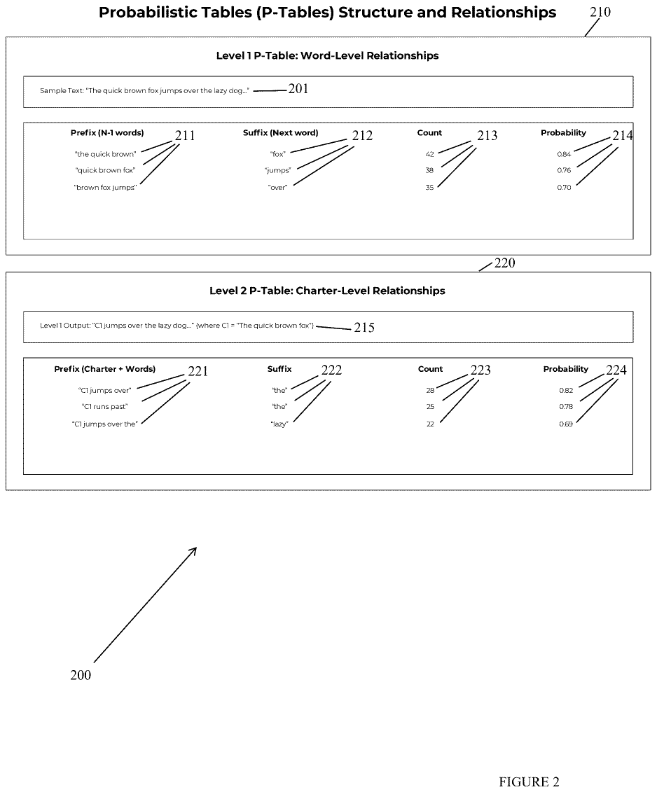

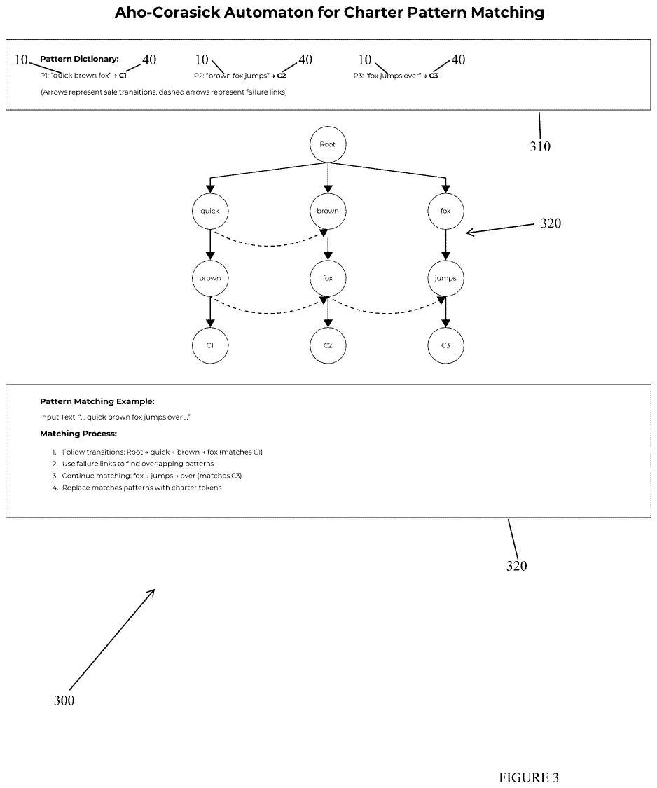

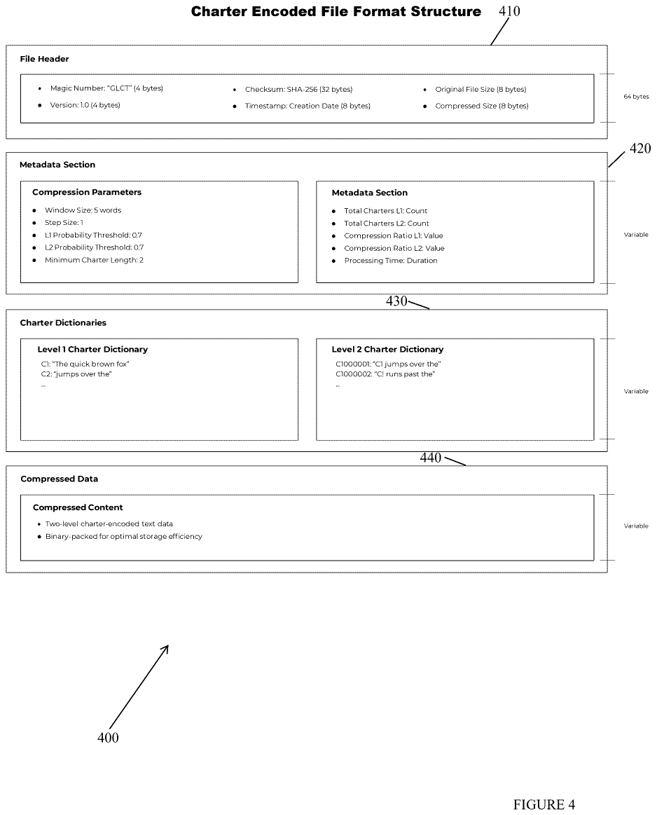

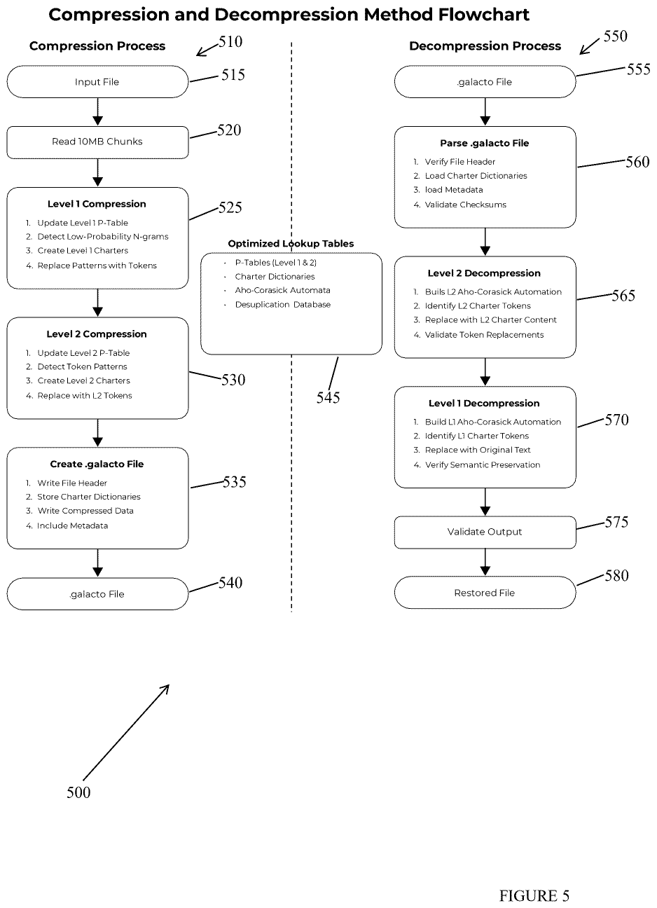

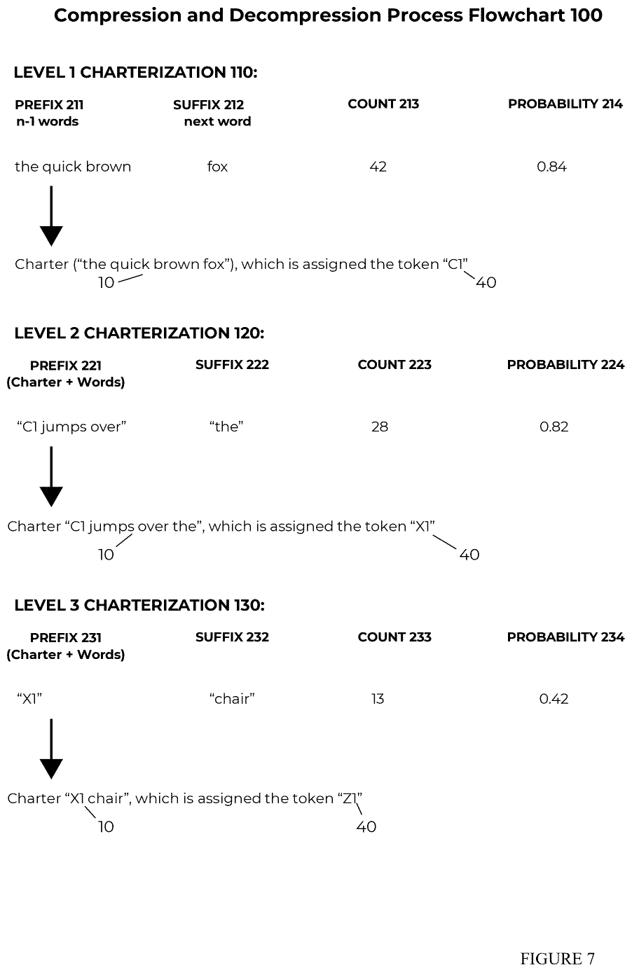

Key aspects of the various embodiments of the invention include:
Semantic Preservation 70: various embodiments of the present invention ensure that the compressed data retains the intrinsic meaning and functionality of the original file upon decompression. In other words, the compressed data (also referred to herein as the “output” of the various levels of compression) is a semantically accurate representation of the input data 201.
Multi-Level Charterization 20: various embodiments of the present invention implement a two-level charterization process 20 that progressively compresses data by identifying and replacing low-probability n-grams 30 and token sequences 60 with unique tokens 40 (see FIGS. 1, 5, and 7). For ease of discussion herein, various embodiments of the present invention are explained with reference to a two-level charterization process 20. However, any number of levels (n-levels or n levels) can be used with the present invention. Various embodiments of the present invention can be configured to work with n-levels, where “n” is greater than or equal to 1. The levels describe the degrees of compression, usually with diminishing returns. For most practical embodiments, two levels is sufficient for, as an example, training a large-language model. However, additional charterization levels can be used or employed, and, as a non-limiting example, FIG. 7 illustrates three levels of charterization.
Optimized Lookup Tables 200: various embodiments of the present invention utilize P-Tables 200 and deduplication databases 624 to store prefix-suffix relationships and ensure uniqueness of charters 10, enhancing compression effectiveness (see FIGS. 2, 5, and 7).
Pattern-Matching Automata 300: various embodiments of the present invention integrate efficient pattern-matching automata for detecting and replacing charters in the data (see FIG. 3). Aho-Corasick Automata is one non-limiting example for a pattern-matching automata that can be used with one embodiment of the present invention.
New File Format 400: various embodiments of the present invention introduce a unique file extension (e.g., a charter-encoded file format 400) to represent the compressed data, facilitating recognition and handling by systems and applications. FIG. 4 illustrates one embodiment of a charter-encoded file format 400. The structure of the file format in FIG. 4 contains a file heater 410, metadata 420, information from the charter dictionaries 430, and the compressed data 440.
Virtual Compression Service via application programming interface (“API”): various embodiments of the present invention provide a virtual service allowing users to compress and decompress data over an API, enabling integration with various applications and systems (see FIG. 5).

### Definitions.

“Charters 10”: Sequences of data elements identified through statistical analysis and pattern recognition, wherein said sequences exhibit lower entropy characteristics than surrounding data. Charters 10 are computational constructs derived from input data streams 201 (including but not limited to genomic sequences, textual content, binary data, or any structured or unstructured data format) through a process of probabilistic analysis and sequential pattern detection. A charter 10 is defined as a sequence of elements meeting or exceeding a predetermined minimum length threshold, where the probability of the sequence occurring, as determined through analysis of n-gram 30 frequency distributions in probabilistic lookup tables 200, falls below a specified probability threshold value for sequences of equivalent length. FIGS. 1, 4, and 7 illustrate some examples of charters 10.

“Charterization 20” or “Charterization process 20”: The systematic process of analyzing and transforming input data 201 to identify and extract charters 10. In most embodiments, this process comprises multiple computational stages including, but not limited to: (a) data 201 segmentation and tokenization 50, (b) probability table 200 construction and maintenance, (c) n-gram 30 analysis, (d) entropy calculation, (e) sequence probability assessment, (f) charter 10 candidate identification, (g) charter 10 validation, and (h) charter 10 extraction and storage. The process may be applied iteratively across multiple levels of abstraction to identify increasingly complex pattern structures. FIGS. 1 through 5 and 7 illustrate elements of various embodiments of charterization 20 according to the present invention. As a non-limiting example, FIG. 7 illustrates a level 1 charterization 110, a level 2 charterization 120, and a level 3 charterization 130 (or level n charterization 130, which is any level beyond 2).

“n-gram 30”: A contiguous sequence of “n” elements from a given input stream 201, where elements may be characters, words, tokens, or any other discrete units appropriate to the data type being processed (see FIGS. 1, 5, and 7). N-grams 30 serve as the fundamental units for probability calculation and pattern detection, with “n” representing the sequence length parameter that may be dynamically adjusted based on processing requirements and data characteristics. One point of novelty of the present invention is the use of n-grams 30 having a fixed length, whereas a charter 10 can be indefinitely large and a non-uniform length.

“Token 40”: A token 40 is a unique identifier assigned to represent a specific charter 10 or sequence pattern, serving as a compressed representation of the original data sequence. Tokens 40 are generated through a deterministic process ensuring uniqueness within their scope of application, reversible mapping to original content, efficient storage and retrieval characteristics, and maintenance of semantic relationships. As illustrated in FIG. 1, “C1” is a Level 1 token 40 that represents “The quick brown fox”. Also shown in FIG. 1, “000001” and “000002” are Level 2 tokens 40 representing “jumps over the” and “runs past the” respectively. Level 2 tokens 40 (and higher levels) can embed lower level tokens 40 within their content. In FIG. 7, X1 is a Level 2 token 40 and Z1 is a level 3 token. For additional clarity, “token 40” is the label given to “C1”, “C2”, “C3”, etc., whereas the content of the token 40 is a “charter 10.” For example, C1 is the token 40 which describes the charter 10, “The quick brown fox.” FIG. 7 shows tokens 40 “C1”, “X1”, and “Z1”. A token 40 is an alpha-numeric symbol for a charter 10 that is shorter than the charter 10.

“Tokenization 50”: The systematic process of converting input data 201 into a sequence of discrete tokens 40 (see FIG. 1). This process encompasses input stream 201 segmentation, element boundary detection, token 40 assignment, token 40 relationship mapping, and token 40 storage and indexing mechanisms, ensuring consistent and reversible transformation of input data 201 into tokenized representations 40.

“Token Sequence 60”: An ordered collection of tokens 40 representing a higher-level pattern or relationship within the data, potentially spanning multiple charter levels, and maintaining both structural and semantic relationships between constituent elements. Token sequences 60 may themselves become candidates for higher-level charter 10 formation through iterative application of the charterization process 20.

“Semantic Preservation 70”: The maintenance of meaningful relationships and information content throughout the compression and decompression processes. This includes retaining original data meaning, preserving structural relationships, maintaining contextual information, ensuring pattern relationships remain intact, and respecting information hierarchy throughout all processing stages.

“Vowel Ratio 80”: A quantitative metric used in charter 10 classification and analysis, calculated as the ratio of vowel occurrences to total character count within a charter 10. This metric serves as one component of a multi-dimensional classification system that aids in charter 10 categorization, pattern similarity assessment, semantic relationship identification, and charter 10 quality evaluation. The vowel ratio 80 provides insight into linguistic and structural characteristics of charter 10 patterns, particularly in text-based applications.

To explain the interrelationship among the previously-defined words for one embodiment of the invention, and within the context of FIGS. 1, 2, and 7, “prefix” and “suffix” refer to how a p-table 200 is structured. The p-table 200 contains “prefix”, “suffix”, “token”, and “count” columns (see FIG. 2). These columns map the relationships of words and/or charters 10. As illustrated in the embodiment in FIG. 2. A level 1 p-table 210 stores the level 1 prefixes 211, the level 1 suffixes 212, the level 1 prefix-suffix combinations 213, and the level 1 probabilities 214 of the level 1 prefix-suffix combinations 213 for the input data 201. Also shown in FIG. 2 is a level 2 p-table 220, which stores the level 2 prefixes 221, the level 2 suffixes 222, the level 2prefix-suffix combinations 223, and the level 2 probabilities of the prefix-suffix combinations 224 of the level 1 output 215. The level 1 p-table 210 contains the word-level relationships and the level 2 p-table 220 contains the charter 10 level relationships. As illustrated in FIG. 2, the probability 214 is the count 213 of a specific suffix 212 divided by the total count of all suffixes 212 for the given prefix 211. A level 3 P-table (or any level higher than level 2) contains prefixes 231, suffixes 232, prefix-suffix combination counts 233, and the probability 234 of each prefix-suffix combination. Low probability sequences (below a predetermined threshold) become candidates for charter creation 20.

As another example, here is a row from another embodiment of a level 1 p-table 210 database:

| Prefix 211 | Suffix 212 | Token 40 | Count 213 |
|---|---|---|---|
| A | masterly | C8 | 1 |

In this p-table 210, “a masterly” occurs once and is assigned a token 40 as C8. “A” is the prefix 211 and “masterly” is the suffix 212. Likewise, the same database may contain chunks of multiple words as follows:

| Prefix 211 | Suffix 212 | Token 40 | Count 213 |
|---|---|---|---|
| And the | old | C997 | 3 |

In this p-table 210, C8 and C997 are tokens 40. Tokens 40 are a symbolic representation which acts as an identification for the p-table entry containing a prefix/suffix combination or relationship. Charters 10 in the database are prefix+suffix. Therefore, ‘And the old’ is a charter 10, with ID C997.

Token patterns 65 are a precursor to level 2 charterization 20. For example, when a pattern 65 of ‘C993 C997 C124 and the C834’ appears repeatedly in the text, one embodiment of the present invention can make a level 2 token 40 which represents ‘C993 C997 C124 and the C834’ as X2 (a token 40).

Semantic patterns are the same as token patterns 65 by design. It is intended that the ‘semantic integrity’ of the sequence is preserved through charterization 20. What that means is that those regions can be directly substituted with the tokens 40 and the sentence meaning does not change.

For another non-limiting example, below is a blurb from a compressed file (a portion of War and Peace):
X1 obtain C74 Empress Marya Fedorovna C75 her eyes to indicate C77 right C79 desired or was pleased with. “Baron Funke C81 Empress by her sister,” was all she said, in a dry and mournful tone. As she named the Empress, Anna Pavlovna's C83 sincere devotion C84 time C86 Majesty had deigned C87 clouded over with sadness. The prince C89 habitual to her, Anna Pavlovna wished both to rebuke him (for daring C91 man recommended to the Empress) and C93 daughter came C95 by her? “They say she is amazingly beautiful.”
Token sequences 60 are not a part of the level 1 charterization process 20, only Level 2. This is because tokens 40 are assigned to the data or text chunks or segements (discovered charters 10) after the level 1 process.

With respect to n-grams 30, the number of words in the window with a shifting parser is determining the probability that the next word is what it is (for one embodiment of the present invention. To clarify:
if__name__==“__main__”:
parser=AdvancedTextCharterParser(
min_window_size=5, #Number of words in window (N-gram size)
step_size=1,
probability_threshold_level1=0.95, #Threshold for detecting low probability N-grams at Level 1
probability_threshold_level2=0.95, #Threshold for detecting low probability token sequences 60 at Level 2
min_charter_length=2 #Minimum charter length in words

These are the parameters related to generation of charters 10 in one embodiment of the present invention. The user defines a window of 5, that is the n-gram 30 size. For each step, the invention calculates the frequency with which that 5 word sequence appears. Charters 10 occur when there are a string of these sequences side by side (step size 1) that all have a probability less than (or greater than) probability_threshold_level1 and level2. This is what enables the present invention to detect charters 10 of any length. Embodiments of the invention use n-grams 30, but the final charter 10 is not an n-gram 30 itself.

Multi-Level Charterization Method 100. One embodiment of the compression method 100 and system 600 employs a two-level charterization process 20 to progressively reduce data size while preserving semantic integrity 70. FIG. 1 illustrates one embodiment of the present invention's multi-level charterization method 100. Input text or data 201 (used interchangeably herein) is received, read, parsed and/or processed 101 as the first step in this method 100. The input data 201 in FIG. 1 is “The quick brown fox jumps over the lazy dog. The quick brown fox runs past the sleepy cat.” The next step is performing a level 1 charterization 110 on the input data 201. The first sub-step in this charterization 110 is n-gram detection 111, which is the identification of frequently occurring word patterns, such as “The quick brown fox”. Second is charter 10 assignment 112 in which a level 1 charter 10 “C1” is assigned to the text, “The quick brown fox”, which is then stored in a deduplication database 624. The third sub-step is text transformation 113, in which the identified patterns are replaced by charters 10 (“C1 jumps over the lazy dog. C1 runs past the sleepy cat.) This transformed text becomes the level 1 output 114 and a level 1 charter dictionary is updated with C1=The quick brown fox. Various embodiments of the present invention employ pattern dictionaries 310, which refers to both level 1 dictionaries and level 2 or above dictionaries (which also could be the same dictionary configured to handle multiple levels of matching). See FIG. 3 for an example of a pattern dictionary 310. FIG. 3 also illustrates one embodiment of a pattern matching method or process 320.

The embodiment illustrated in FIG. 1 then employes a level 2 charterization 120, in which patterns are detected in the level 1 output 121. These patterns can contain both level 1 charters 10 and regular text (“C1 jumps over the” and “C1 runs past the”.) Then level 2 charters 10 are created and assigned 122. As shown in FIG. 1, “C1 jumps over the” is assigned “C1000001” and “C1 runs past the” is assigned “C2000002”, but they also can be assigned tokens 40 such as “X1”, “X2”, “B1”, “B2”, etc. These become the level 2 output (or the final compressed text 440 in this example) and a level 2 charter dictionary is updated 123 as shown in FIG. 1. The compressed text 440 retains semantic integrity 70 and can be used without being decompressed. Additional levels of compression could be added to this method 100.

One embodiment of Level 1 Charterization 20 includes the following steps:
Tokenization 50: The input data 201 is tokenized 50 using regular expressions to identify meaningful units (e.g., words in text data 201). As is known in the art, a “regular expression” (often abbreviated as regex or regexp) is a sequence of characters that defines a search pattern. This pattern can be used to match, locate, and manage text. Regular expressions are commonly used in programming, text processing, and search applications to find specific strings, validate data, extract substrings, or perform search-and-replace operations. They provide a flexible way to define rules for text matching using a combination of literal characters, metacharacters, and operators.
P-Table 200 Generation: A probabilistic table 200 is created using an appropriate database (an SQLite database as one non-limiting example) that can store prefix-suffix relationships (also referred to herein as prefix-suffix combinations) and their counts. FIG. 2 illustrates two embodiments of a p-table 200, namely, a level 1 p-table 210 (containing word-level relationships) and a level 2 p-table 220 (containing charter-level relationships).
Probability Calculation: The probabilities of suffixes given prefixes are calculated to identify low-probability n-grams 30.
Charter 10 Detection: Low-probability n-grams 30 are detected as potential charters 10.
Charter 10 Classification: Detected charters 10 are classified based on entropy, length, and vowel ratio 80.
Deduplication and Token 40 Assignment: Unique tokens 40 are assigned to new charters 10, and deduplication databases 624 ensure each charter 10 is unique.
Pattern-Matching Automaton Construction 300: An automaton 300 is built to efficiently detect and replace charters 10 in the data with their corresponding tokens 40.

One embodiment of Level 2 Charterization 20 includes the following steps:
Tokenization 50 of Level 1 Output: The output from Level 1 is tokenized, treating the tokens 40 from Level 1 as new units.
P-Table 220 Generation and Probability Calculation: Similar to Level 1 but operating on Level 1 tokens 40.
Charter 10 Detection and Classification: Low-probability token sequences 60 are detected and classified.
Deduplication and Token 40 Assignment: Unique tokens 40 are assigned to Level 2 charters 10.
Pattern-matching Automaton Update 300: The automaton 300 is updated to handle Level 2 charters.

Additional levels of charterization 20 can be added to various embodiments of the present invention to achieve the desired level of compression.

One embodiment of a Compression Process includes the following steps:
Data Input 201: The original file is read in chunks or segments (or smaller portions) so that larger files can be handled more efficiently. For small files, this chunking may be unnecessary.
Level 1 Processing: Each segment or input data 201 undergoes Level 1 charterization 20.
Level 2 Processing: The output from Level 1 is further processed in Level 2 charterization 20.
Compressed Output Generation: The twice-charterized data is appended to the compressed output file.
Compression Statistics Tracking: Detailed statistics are recorded, including starting and ending sizes, and compression ratios for both levels.

One embodiment of a Decompression Process includes the following steps:
Reading Compressed Data 555: The compressed file is read and tokens 40 are identified.
Automaton Utilization 300: The same pattern-matching automata 300 and lookup tables are used in reverse to map tokens 40 back to original charters 10.
Data Reconstruction 560, 565, 570: The original data is reconstructed by replacing tokens 40 with their corresponding charters 10.
Integrity Verification 575: The reconstructed data is verified against checksums or other integrity measures included in the metadata.

One embodiment of using Optimized Lookup Tables includes the following steps:
P-Tables 200 in (SQLite) Databases: Prefix-suffix relationships or combinations and counts are stored efficiently, allowing quick probability calculations.
Deduplication Databases: Ensure uniqueness of charters and facilitate quick lookups.
Adaptive Learning: The system updates the lookup tables based on new data patterns encountered, improving compression over time.

One embodiment of the Application of an Automata 300 (pattern-matching or otherwise) for pattern matching 320 includes the following steps:
Efficient Charter 10 Detection: Automata are used to detect charters 10 within the data 201 quickly.
Replacement with Tokens 40: Identified charters 10 are replaced with their assigned unique tokens 40.
Automaton 300 Updates: As new charters 10 are detected the automata 300 are updated accordingly.

One embodiment of a Charter-Encoded File Format 400 Specification includes the following steps:
Unique File Extension: The new file type 400 uses a unique extension (the charter-encoded file format 400, one non-limiting example is .galacto), distinguishing it from other file formats.
Metadata Inclusion: Compressed files include metadata 420 such as version information, compression settings, and checksums for integrity verification.
Compatibility Considerations: The file format is designed to be compatible with various systems and applications, facilitating adoption.

One embodiment implementing Virtual Compression Service and/or a Virtual Decompression Service via API includes the following:
API Access: Compression and decompression functionalities are accessible via an API, allowing integration with applications and systems.
Cloud-Based Implementation: The service can be hosted on cloud platforms, providing scalability and accessibility.
Security Measures: Data transmitted via the API is secured using encryption and authentication protocols.
   One embodiment of the present invention comprises storing compressed data in at least one cloud-based database (remote database) that is configured to be accessible by multiple users through an API or another user interface. This would enable multiple users to access a database of data compressed according to the present invention.

Non-Limiting Example Applications of the Systems, Methods, and Files of the present invention:
Data Storage Efficiency: various embodiments of the present invention reduce storage requirements for large files across various domains.
Improved Transmission: various embodiments of the present invention enhance data transmission efficiency over networks by reducing file sizes.
Cross-Platform Support: various embodiments of the present invention the method's universal design allow it to be used across different operating systems and platforms.
Use Cases: various embodiments of the present invention applicable in natural language processing, genomic data analysis, multimedia compression, and more.

Implementation Details Based on the Provided Script. One embodiment of the invention is implemented using a Python-based system that processes large datasets efficiently through segment-wise processing and multi-threading.

Key Components of this One Embodiment of the Present Invention:
1. Tokenization Module 50:
   Uses regular expressions to tokenize input data 201.
   Handles large text files by processing data in manageable segments.
   Manages leftover words that may span across segments.
2. Probabilistic Tables (P-Tables 200):
   Implemented using databases (e.g., SQLite databases) for both Level 1 and Level 2 charterization 20.
   Store prefix-suffix relationships with associated counts.
   Use optimized database settings (e.g., WAL mode, indexing) for performance.
3. Deduplication Databases 624:
   Ensure uniqueness of charters 10 by storing them along with unique tokens 40.
   Use databases 624 (e.g., SQLite databases) with indexing for efficient lookups.
4. Pattern-Matching Automata 300:
   Used for efficient pattern matching 320 to detect and replace charters.
   Separate automata for Level 1 and Level 2 charterization 20.
   Automata 300 are updated incrementally as new charters 10 are detected.
5. Compression Statistics Tracking:
   Records detailed statistics for each data segment processed.
   Includes starting and ending sizes, compression ratios, and segment numbers.
   Outputs statistics to a CSV file for analysis.
6. Logging Mechanism:
   Comprehensive logging to both file and console.
   Logs operations, errors, and system states for monitoring and debugging.
7. Concurrency and Thread Safety:
   Uses threading locks to ensure safe concurrent access to shared resources.
   Guarantees data integrity during multi-threaded operations.

Processing Workflow for one embodiment of a method of the present invention:
1. Initialization:
   Set up output directories and initialize logging.
   Initialize P-Tables 200 and deduplication databases 624 for both levels.
   Load existing charters into the pattern-matching automata 300.
2. Processing Input File 201:
   Read the input file 201 in large segments (e.g., 10MB).
   Tokenize 50 the segment and handle any leftover words.
3. Level 1 Charterization 20:
   Update the Level 1 P-Table 210 with prefix-suffix combinations 213.
   Detect new charters 10 based on probability thresholds.
   Classify, deduplicate, and assign unique tokens 40 to new charters 10.
   Update the pattern-matching automaton 300 and replace charters 10 in the text 201.
4. Level 2 Charterization 20:
   Tokenize 50 the Level 1 charterized text.
   Update the Level 2 P-Table 220 and detect new charters 10.
   Repeat the classification, deduplication, and token assignment process.
   Update the Level 2 automaton 300 and replace charters 10.
5. Output Generation:
   Append the Level 2 charterized text to the compressed output file 400.
   Flush any remaining data in buffers.
6. Finalization:
   Close database connections.
   Log the completion of processing with total time taken.

FIG. 5 illustrates one embodiment of a compression and decompression method 500 of the present invention. For this embodiment, the compression process or method 510 begins with the receipt of an input file or data 515. This input data is read into smaller segments 520 (in FIGS. 5, 10 MB segments but other sizes can be used). These segments undergo a level 1 compression 525 comprising the steps of: (1) updating a level 1 p-table; (2) detecting low-probability n-grams; (3) creating level 1 charters; and (4) replacing detected patterns with tokens. The output from the level 1 compression then undergoes a level 2 compression 530, which comprises the steps of: (1) updating a level 2 p-table; (2) detecting token patterns; (3) creating level 2 charters; and (4) replacing the token patterns with level 2 tokens. The output from the level 2 compression 530 is used to create a charter-encoded file 535, which comprises the steps of: (1) writing a file header; (2) storing the charter dictionaries; (3) writing the compressed data; and (4) including any metadata. This produces the final charter-encoded file 540.

One embodiment of a decompression process 550 also is illustrated in FIG. 5. As illustrated a charter-encoded file 555 is read or parsed 560. The parsing process 560 comprises the steps of: (1) verifying the file header; (2) loading the charter dictionaries; (3) loading the metadata; and (4) validating the checksums. The output from the parsing 560 then undergoes a level 2 decompression 565 comprising the steps of: (1) building a level 2 pattern-matching automation; (2) identifying the level 2 tokens; (3) replacing the level 2 tokens with content; and (4) validating the token replacement. The output from the level 2 decompression then undergoes a level 1 decompression 570 comprising: (1) building a level 1 pattern-matching automation; (2) identifies the level 1 tokens; (3) replacing the level 1 tokens with original/input text; and (4) verifying the semantic preservation or accuracy. This results in validated output 575 and a restored file 580.

As shown in FIG. 5, both the compression method 510 and the decompression method 550 have access to and utilize the optimized lookup tables 545, which include the level 1 and level 2 p-tables, the charter dictionaries, the pattern-matching automata, and the Deduplication database(s).

FIG. 6 illustrates one embodiment of a system 600 for compressing and/or decompressing data according to the present invention. The system 600 comprises a memory 610, which includes at least one buffer 611 and a variety of caches, including but not limited to a pattern cache 612, a level 1/level 2 cache 613, and a level 3 cache 614. The embodiment illustrated in FIG. 6 also has a variety of storage mechanisms including but not limited to a non-volatile memory express storage (“NVMe”) 621, a WAL cache 622 (a memory area where a database system temporarily stores the Write-Ahead Log (“WAL”), a p-table database 623, and a deduplication database 624 (“Dedup”). The memory 610 and the storage 620 are in communication with the processor 630. The processor 630 in the embodiment illustrated in FIG. 6 comprises a charter detection unit 631, a pattern matching unit 632, a compression unit 633, and a stat collection unit 634.

Error Handling and Robustness. With respect to exception handling, one embodiment of a method and system of the present invention includes try-except blocks to catch and log exceptions, ensuring that errors do not halt the processing pipeline. For data integrity of one embodiment of the present invention, threading locks and careful management of shared resources prevent data corruption during concurrent operations.

The various embodiments of systems and methods of the present invention are novel in light of the existing technology in this field in several ways. First, one embodiment of the present invention utilizes a 5-gram 30 , rather than a 3-gram 30, which is used by similar technologies. However, as discussed previously, a wide variety of n-grams 30 can be used with the present invention beyond five.

Various embodiments of the present invention comprise a form of compression that does not change the entropy of the compressed content. Various embodiments also comprise a form of compression which enables the storage of sensitive information in a secondary location, which cannot be decoded by the person or entity that has the secondary database. Additionally, in some embodiments, semantic integrity is stored in the secondary database and the entropy is stored in the client's location.

Various embodiments of the present invention use a probability table 200 and do Q-learning on the tables. The entropy (degree of disorder) within the data to be compressed is determined. In text, vowel-count is determined. For something like genomics, the GC-content is determined, where “ATCG” represents the four bases or nucleotides that make up DNA: adenine (“A”), thymine (“T”), cytosine (“C”), and guanine (“G”). These bases are the building blocks of DNA. Alternatively, any of the pairings of the nucleotide bases, ATCG, can be calculated. For genomics and text, various embodiments of the present invention determine length. These various embodiments then turn these three values into a token 40 and then enumerate the entries that have the same charter ID. This yields a smaller search space and results in a high-degree of compression. These systems and methods can be used for retrieval or compression.

Another distinguishing factor between some embodiments of the present invention and the prior art is that these embodiments of the present invention do not use strictly n-grams 30 in the analysis. For the present invention, although n-grams 30 are calculated, they are used to populate a P-table 200, which is then used to determine the presence of charters 10.

Some of the prior art utilizes a fixed-sized, static dictionary whereas various embodiments of the present invention utilize a dynamic dictionary that can grow in size as the system operates performing new compression on expanded datasets. Various systems of the present invention perform better over time-through the process of compression. These systems use the new data they encounter to further update the dictionary and P-tables which can be utilized to compress files to a greater degree with greater efficiency.

Some prior art uses n-grams directly in a table. Various embodiments of the present invention take the n-grams and then take n-grams of n-grams plus text using the Level 2 charterization 20 to accomplish compression. This enables n-compression steps.

Charterization 20 to Train LLMs. Large Language Models (“LLMs”) like GPT-4 have transformed various industries by enabling sophisticated natural language processing tasks. However, the training of these models is computationally intensive, requiring vast amounts of data and significant processing power. As the demand for more efficient and accessible AI solutions grows, innovative methods to reduce training data and computational overhead are imperative. Techniques such as data pruning, knowledge distillation, and model quantization have been extensively researched and applied. While these methods have yielded significant improvements, they often involve trade-offs between efficiency and model performance. Tethering 90 distinguishes itself by enabling the training of an LLM through a reduced data set (compression) which encodes for all of the original data (semantic integrity 70). The charterization process 20 allows for a unique data compression technique that maintains the semantic integrity of the original text 201 while drastically reducing its size. Additionally, techniques like tokenization 50 and embedding have laid the groundwork for efficient text representation in natural language processing. Tethering 90 builds upon these foundational concepts, introducing a higher-order abstraction that encapsulates recurring textual structures into charters, thereby enhancing data efficiency without compromising linguistic richness. In short, “tethering 90” is the training of LLMs by using the novel systems and methods of charterization 20 of the present invention.

Tethering 90 is a novel approach to address these challenges by employing charterization 20, a process that identifies and encodes frequently occurring textual patterns into compact representations called charters 10. Tethering 90 allows for the training of LLMs on a significantly reduced dataset. This not only diminishes the required storage and computational resources but also expedites the training timeline, making LLM development more feasible for organizations with limited resources.

At the heart of the present invention's novel tethering 90 systems and methods lie the concept of charterization 20, a process that transforms extensive textual data 201 into a compact, charter-based representation. This transformation is achieved through the identification of frequently occurring patterns or sequences within the text 201, which are then encoded into unique placeholders known as charters 10. The resulting charterized text retains the essential semantic and syntactic properties of the original corpus while occupying a fraction of its size. One embodiment of the LLM training pipeline with tethering 90 can be conceptualized as follows:
1. Charterization 20: Analyze the original text to identify and encode recurring patterns into charters.
2. 2. LLM Training: Train the LLM on the charterized text, leveraging the reduced data size to optimize resource utilization.
3. 3. Reconversion: Post-training, convert the model's output from charters back into plain text, restoring the original textual content.

This framework of one embodiment of the present invention ensures that the LLM benefits from the semantic depth of the original corpus while operating within a constrained data environment, facilitating faster training cycles, and reducing computational overhead.

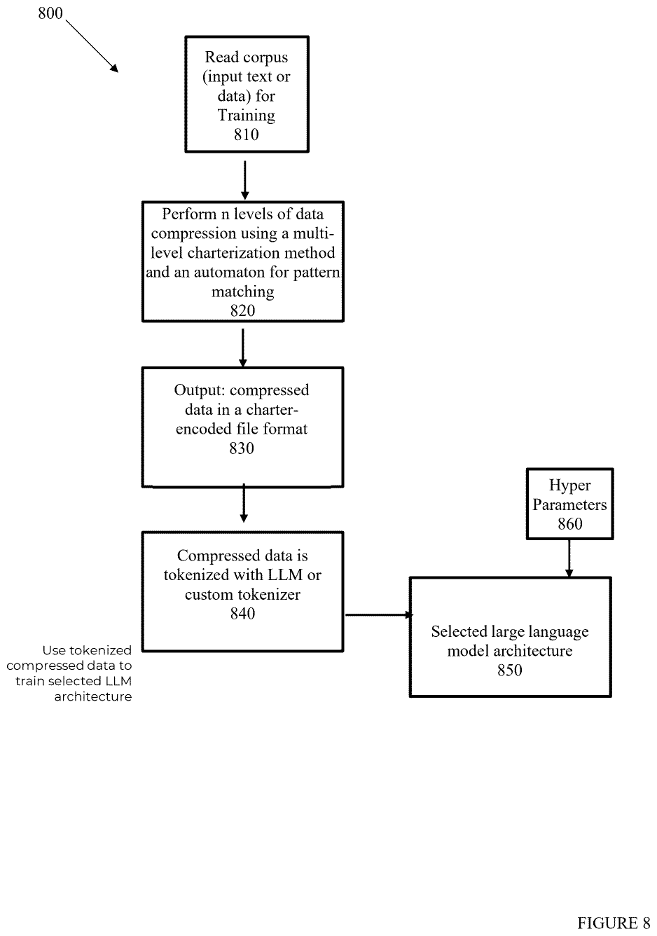

For LLM training, the charterization process 20 occurs according to any of the previously-described systems or methods of the present invention. One example embodiment is illustrated in FIG. 8. An LLM training method 800 of the present invention comprises reading the corpus (or input text and/or data) to b used for training 810. Then a predetermined (“n”) levels of data compression are performed using an embodiment of the multi-level charterization method of the present invention and an appropriate pattern-matching automaton 820. The output from the compression is compressed data in a charter-encoded file format of the present invention 830. The output is tokenized with the LLM or a customer tokenizer 840. Then, the following steps can be employed, in one embodiment of the present invention:
1. Model Architecture Selection 850: Choose an appropriate LLM architecture (e.g., Transformer-based models) tailored to the size and complexity of the charterized data.
2. Training Configuration 860: Configure hyperparameters such as learning rate, batch size, and number of epochs to suit the compressed dataset.
3. Training Execution: Initiate the training process using the charterized corpus. The reduced data size allows for faster training times and lower memory consumption.
4. Validation and Evaluation: Continuously assess the model's performance using validation datasets to ensure that charterization 20 does not adversely affect linguistic capabilities. This step is not illustrated in FIG. 8, but any method or system of the present invention can be configured to perform this step continuously to improve the model's performance.

In one embodiment of the system or method of the present invention, these steps can be accomplished by utilizing deep learning frameworks. For example, one embodiment can utilize frameworks like TensorFlow® or PyTorch® for model training. One embodiment can implement GPU acceleration to expedite the training process (for parallel processing). One embodiment can save model states at intervals to prevent data loss and facilitate iterative training to create checkpoints.

To convert the LLM's output from charters back into the original plain text format and to restore the semantic and syntactic nuances of the source data, the following steps are implemented by one embodiment of a system or method of the present invention:
1. Output Generation: The trained LLM generates output in the charterized format during inference.
2. Charter Mapping: Use the previously established mapping between charters and their corresponding textual patterns to identify placeholders in the output.
3. Placeholder Replacement: Substitute each charter 10 in the LLM's output with its original textual pattern, effectively reverting to plain text.
4. Post-Processing: Apply any necessary formatting or correction to ensure the reconstructed text maintains coherence and readability.

These steps can be accomplished by using the following tools and techniques in one embodiment of the present invention. Pattern-matching automaton 300 can be implemented to facilitate efficient replacement of multiple charters 10 within the generated text. Batch processing can be utilized to handle large volumes of text replacements systematically to ensure

scalability. Validation checks can be implemented to verify the accuracy and completeness of the reconversion process. The final output of this embodiment is a coherent and semantically accurate plain text that mirrors the original corpus, achieved through an efficient and resource-optimized training pipeline.

As mentioned previously, there are numerous applications for the various embodiments of the present invention. The following non-limiting examples relate more specifically using the present invention to teach LLMs. Tethering's 90 ability to compress large textual datasets while preserving semantic integrity opens a myriad of applications across various domains. Tethering 90 can be used in resource-constrained environment, such as organizations or individuals with limited computational resources or storage capacity face challenges in training expansive LLMs. Tethering 90 in these environments enable the training of robust LLMs on minimal hardware by reducing the required dataset size. Additionally, tethering 90 facilitates AI model development in remote or under-resourced locations where access to high-end computational infrastructure is limited.

Rapid prototyping and iterative development can benefit from tethering 90 in scenarios where quick model iterations are essential—such as in startups or research labs—time efficiency is paramount. Tethering 90 can accelerate the training process, allowing for rapid testing and refinement of models. Additionally, tethering 90 enables continuous integration of new data into the training pipeline without significant delays, fostering an agile development environment.

Data privacy and security involving handling sensitive or proprietary data necessitates stringent privacy measures during model training. In this realm, tethering 90 reduces the volume of sensitive data required for training, minimizing the exposure risk. Additionally, tethering 90 facilitates the anonymization of data by encoding identifiable patterns into charters, enhancing data security without sacrificing model performance.

Specialized domain training involves developing LLMs tailored to niche or specialized domains (e.g., medical, legal, technical) often requires extensive and specific datasets. Tethering 90 can aid by efficiently encoding domain-specific terminologies and patterns into charters, allowing the LLM to grasp specialized knowledge with a reduced dataset. Additionally, tethering 90 streamlines the integration of new domain-specific information into the model, enhancing its adaptability and expertise.

Low-latency and edge computing involves deploying LLMs on edge devices (e.g., smartphones, IoT devices) demands models that are both compact and efficient. In this realm, tethering 90 produces smaller model variants trained on compressed data, suitable for deployment on devices with limited processing power and storage. Additionally, tethering 90 enhances real-time processing capabilities by reducing the computational load during inference.

Various embodiments of tethering's 90 effectiveness hinges on their technical implementation, such as it's: (i) data compression efficiency; (ii) computational requirements; (iii) integration with existing frameworks; (iv) scalability and flexibility; (v) data integrity and fidelity; and (vi) security and privacy.

Data compression efficiency of various embodiments of the present invention improves upon data compression ratios by achieving up to 1% of the original corpus size, enabling LLM training on significantly reduced datasets. Additionally, charter 10 granularity can be designated, which determines the level of detail in pattern recognition—ranging from word-level sequences to phrase or sentence-level patterns—to optimize compression without loss of semantic depth. Finally, the encoding schema is relevant because it utilizes a consistent placeholder format (e.g., C0001) to ensure uniqueness and facilitate efficient mapping during reconversion.

The computational requirements of various embodiments of the present invention are impacted by the processing power, the memory usage, and the scalability of the utilized resources. With respect to processing power, optimizing the use of CPU and GPU resources by reducing the data volume decreases the training time and energy consumption. Tethering 90 minimizes RAM and storage requirements by operating on compressed datasets, making it feasible to train LLMs on standard computing hardware. Tethering 90 is scalable, more specifically, it is designed to handle varying dataset sizes and model complexities, allowing for scalability from small-scale projects to large-scale deployments.

Three factors relate to the integration of various embodiments of the present invention with existing frameworks. Many embodiments of the present invention are compatibility with and/or seamlessly integrate with popular deep learning frameworks such as TensorFlow® and PyTorch®, facilitating adoption without necessitating significant alterations to existing pipelines. Various embodiments of the present invention employs the Aho-Corasick algorithm 300 for efficient multi-pattern searching and replacement, ensuring swift charterization 20 and reconversion processes. Many embodiments of the present invention have a modular design, meaning that they are architected in a modular fashion, allowing for customization and extension to accommodate diverse training requirements and workflows.

Various embodiments of the present invention are scalable and flexible. The dynamic charter 10 assignment of some embodiments of the present invention make those embodiments capable of dynamically assigning and updating charters 10 as new patterns emerge, ensuring that the model remains adaptable to evolving datasets. Some embodiments of the present invention incorporate incremental training by supporting incremental model training, enabling the incorporation of new data without retraining from scratch, and thereby conserving computational resources. Additionally, some embodiments of the present invention have cross-domain applicability. These embodiments are applicable across various domains and languages, ensuring versatility in addressing a wide array of natural language processing tasks.

Various embodiments of the present invention are configured to ensure data integrity and fidelity. These embodiments provide for semantic preservation 70 by ensuring that charterization 20 does not compromise the semantic and syntactic integrity of the original text, maintaining the LLM's ability to understand and generate coherent language. Additionally, these embodiments provide for lossless conversion by guaranteeing that reconversion from charters to plain text is lossless, preserving the exact original content without discrepancies.

Within the contexts of security and privacy, tethering 90 provides for data anonymization and secure mapping storage. Data anonymization is accomplished by tethering 90 ability to facilitate the anonymization of sensitive data by abstracting identifiable patterns into non-descriptive charters. Tethering 90 involves secure mapping storage by storing charter 10 mappings securely to prevent unauthorized access or reverse-engineering, enhancing data privacy during and after training.

1. A method for compressing data into semantically preserved representations, comprising:
an electronic system having at least one processor, and a memory coupled to the at least one processor comprising instructions executable by the at least one processor, the at least one processor operable when executing the instructions to:
read input data;
perform a level 1 charterization comprising:
identifying level 1 prefixes, level 1 suffixes, and level 1 prefix-suffix combinations in the input data;
calculating a count for and an associated probability of each of the level 1 prefix-suffix combinations;
updating at least one level 1 probabilistic table with the level 1 counts and associated probabilities;
detecting low-probability level 1 prefix-suffix combinations;
assigning a level 1 token to each detected low-probability level 1 prefix-suffix combination;
replacing each of the low-probability level 1 prefix-suffix combinations with the assigned level 1 token to create a level 1 output;
perform a level 2 charterization comprising:
identifying level 2 prefixes, level 2 suffixes, and level 2 prefix-suffix combinations in the level 1 output;
calculating a count for and an associated probability of each of the level 2 prefix-suffix combinations;
updating at least one level 2 probabilistic table with the level 2 counts and associated probabilities;
detecting low-probability level 2 prefix-suffix combinations;
assigning a level 2 token to each detected low-probability level 2 prefix-suffix combination;
replacing each of the low probability level 2 prefix-suffix combinations with the assigned level 2 token to create a level 2 output; and
store all assigned charters in at least one deduplication database.

2. The method of claim 1, wherein the probability of each step of detecting low-probability prefix-suffix combinations is defined according to at least one predetermined threshold.

3. The method of claim 1, wherein a pattern-matching automaton for charter pattern matching is used for the steps of:
detecting low-probability level 1 prefix-suffix combinations,
assigning a level 1 token to each detected low-probability level 1 prefix-suffix combination,
detecting at least one low-probability level n prefix-suffix combinations, and
assigning a level n charter to each detected at least one low-probability level n prefix-suffix combination.

4. A non-transitory computer-readable storage medium storing one or more programs for compressing data, the one or more programs comprising instructions, which, when executed by at least one processor of an electronic system, cause the electronic system to:
receive input data;
read the input data;
perform a level 1 compression on the input data, the level 1 compression comprising:
update a level 1 P-table based upon a predefined probability threshold,
detect at least one low-probability n-gram,
create a distinct level 1 charter for each low-probability n-gram, and
replace each detected n-gram with its level 1 charter;
perform a level n compression wherein n is a number greater than 1, comprising:
update a level n P-table based upon a predefined probability threshold,
detect at least one low-probability n-gram,
create a distinct level n charter for each low-probability n-gram, and
replace each low-probability n-gram with a level n token to create level n output; and
create at least one charter-encoded file format from the level n output.

5. The method of claim 4 wherein the level 1 compression and the level n compression utilize pattern matching automaton.

6. A method for decompressing data from a compressed format, comprising:
an electronic system having at least one processor, and a memory coupled to the at least one processor comprising instructions executable by the processors, the at least one processor operable when executing the instructions to:
read a plurality of compressed data and associated metadata containing at least one token;
utilize a pattern-matching automata and at least one lookup table to map each tokens back to a corresponding charter;
reconstruct an original data by replacing each token with its corresponding charters to produce decompressed data; and
verify the integrity and functionality of the decompressed data.

7. The method of claim 6, wherein the compressed data is stored in at least one cloud-based database that is configured to be accessible by multiple users through an application programming interface.

8. A method of using the charter-encoded file format of claim 4 in its compressed state, the method comprising:
accessing a plurality of compressed data wherein the compressed data comprises n-level charter-encoded text data having semantic accuracy preserved; and
reading the compressed data without decompressing the data.

9. The method of claim 8, also comprising:
training a large language model on the compressed data comprising:
selecting a large language model architecture that is appropriate for the compressed data;
configuring hyperparameters such as learning rate, batch size, and number of epochs to suit the compressed data;
initiating the training process using the compressed data; and
validating the model continuously during training.

10. The method of claim 8, wherein the compressed data is compressed genomic data and the method further comprising:
employing a genomic sequence processing mechanism enabling direct analysis of the compressed genomic data, wherein pattern matching, taxonomic classification, and evolutionary comparisons are performed on the compressed data; and
utilizing charter relationships to identify pathogenic signatures and perform sequence alignments on the compressed data.

11. A system for semantically preserving data compression, the system comprising at least one processor, and a memory coupled to the at least one processor comprising instructions executable by the at least one processor, the at least one processor operable when executing the instructions to:
read input data;
identify level 1 prefixes, level 1 suffixes, and level 1 prefix-suffix combinations in the input data;
calculate a count for and an associated probability of each of the level 1 prefix-suffix combination;
update at least one level 1 probabilistic table with the level 1 counts and associated probabilities;
detect low-probability level 1 prefix-suffix combinations;
assign a level 1 token to each detected low-probability level 1 prefix-suffix combination;
replace each of the low-probability level 1 prefix-suffix combinations with the assigned level 1 charter to create a level 1 output;
identify level 2 prefixes, level 2 suffixes, and level 2 prefix-suffix combinations in the level 1 output;
calculate a count for and an associated probability of each of the level 2 prefix-suffix combination;
update at least one level 2 probabilistic table with the level 2 counts and associated probabilities;
detect low-probability level 2 prefix-suffix combinations;
assign a level 2 token to each detected low-probability level 2 prefix-suffix combination;
replace each of the low probability level 2 prefix-suffix combinations with the assigned level 2 token to create a level 2 output; and
store all assigned tokens in at least one deduplication database.

12. The system of claim 11, wherein the processor also is configured to decompress the level 2 output by performing the steps of:
reading the level 2 output;
utilizing a pattern-matching automata and at least one lookup table to map each token back to its corresponding charter; and
reconstructing the input data by replacing each token with its corresponding charters to produce decompressed data.

13. The system of claim 11 also comprising at least one optimized lookup table stored in at least one database for mapping tokens to charters.

14. The system of claim 13, also comprising at least one deduplication database used to ensure that each charter is unique.

15. The system of claim 11, also comprising an interface for receiving the input data and providing the compressed output data.

16. The system of claim 12, also comprising an application programming interface for enabling remote access to the compression and decompression functionalities.

17. A computer implemented method for transforming input data into a charter-encoded file format, the method employing at least one processor, and a memory coupled to the at least one processor comprising instructions executable by the at least one processor, the at least one processor operable when executing the instructions to:
receiving a plurality of input data;
reading the input data;
performing a level 1 compression on the input data, the level 1 compression comprising:
updating a level 1 P-Table based upon a predetermined probability threshold,
detecting low-probability n-grams,
creating at least one distinct level 1 charter, and
replacing each detected n-grams with a token;
performing a level n compression wherein n is a number greater than 1, comprising:
updating a level n P-Table based upon a predetermined probability threshold,
detecting low-probability n-grams,
creating at least one distinct level n charter, and
replacing each level n charter with a level n token to create level n output; and
creating at least one charter-encoded file format from the level n output.

18. A computer implemented method for compressing and decompressing data using a computing device comprising a processor in communication with a non-transitory processor-readable storage medium and a memory, the method configured to:
receive input data;
read the input data into smaller data segments;
process the data segments through a level 1 compression to generate level 1 output;
process the level 1 output through a level 2 compression to generate level 2 output;
create a charter-encoded file from the level 2 output;
parse the charter-encoded file;
perform a level 2 decompression on the charter-encoded file;
perform a level 1 decompression on the charter-encoded file to produce a restored file; and
validate the restored file for semantic accuracy.

19. The method of claim 18, wherein the level 1 compression comprises:
updating a level 1 p-table based upon a predetermined probability threshold,
detecting low-probability n-grams in the data segments,
creating level 1 charters that correspond to the low-probability n-grams, and
replacing each of the low-probability n-grams with a defined tokens; and wherein the level 2 compression comprises:
updating a level 2 p-table based upon a predetermined probability threshold,
detecting token patterns in the level 1 output,
creating a corresponding level 2 charter for each of the detected token patterns, and
replacing each of the detected token patterns with the corresponding level 2 token.

20. The method of claim 18, wherein the creating the charter-encoded file comprises:
writing a file header;
storing the created charter in a charter dictionary;
writing the level 2 output; and
incorporating metadata to produce a charter-encoded file.

21. The method of claim 18, wherein the steps of processing the data and processing the level 1 output comprise utilizing a pattern-matching automaton for pattern matching.
